(19) United States
(12) Patent Application Publication
(10) Pub. No.: US 2009/0121812 A1
(43) Pub. Date: May 14, 2009

(54) LOW-PASS FILTER

(75) Inventor: Chia-Hao Mei, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/036,277

(22) Filed: Feb. 24, 2008

(30) Foreign Application Priority Data
Nov. 12, 2007 (CN) 200710202470.6

(51) Int. Cl. H01P 1/20

(52) U.S. Cl. 333/205

(57) ABSTRACT

A low-pass filter (20) is disposed on a substrate (10). The low-pass filter includes an input portion (202), an output portion (208), a first transmission portion (204), a second transmission portion (206), a capacitance component (210), and an inductance component (212). The input portion is used for inputting electromagnetic signals. The output portion is used for outputting electromagnetic signals. The first transmission portion includes a first connection section (2040) electronically connected to the input portion and a first open end (2042). The second transmission portion includes a second connection section (2060) electronically connected to the output portion and a second open end (2062). The capacitance component is electronically connected to the first connection section and the second connection section. The inductance component is electronically connected to the first open end and the second open end.

### BACKGROUND

1. Field of the Invention

The present invention generally relates to filters, and more particularly to a low-pass filter.

2. Description of Related Art

It is well-known that a filter is able to eliminate interference signals for a communication product. Features of an ideal filter are that signal attenuation is zero within a pass band and becomes infinite within a cut-off band, and a transition from the pass band to the cut-off band should be as sharp as possible.

Typically, people improve an efficiency of a filter by adding resonators thereto. However, addition of resonators will increase an area of the filter, thereby increasing the size of the electronic product utilizing the filter.

Therefore, a heretofore unaddressed need exists in the industry to overcome the aforementioned deficiencies and inadequacies.

### SUMMARY

A low-pass filter is disposed on a substrate. The low-pass filter includes an input portion, an output portion, a first transmission portion, a second transmission portion, a capacitance component, and an inductance component. The input portion is used for inputting electromagnetic signals. The output portion is used for outputting electromagnetic signals. The first transmission portion includes a first connection section electronically connected to the input portion and a first open end. The second transmission portion includes a second connection section electronically connected to the output portion and a second open end. The capacitance component is electronically connected to the first connection section and the second connection section. The inductance component is electronically connected to the first open end and the second open end.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a low-pass filter in accordance with an embodiment of the invention;

FIG. 2 is a schematic diagram illustrating dimensions of the low-pass filter of FIG. 1;

FIG. 3 is a graph of test results showing a return loss of the low-pass filter of FIG. 1;

FIG. 4 is another graph of test results showing a return loss of the low-pass filter of FIG. 1; and

FIG. 5 is further another graph of test results showing a return loss of the low-pass filter of FIG. 1.

### DETAILED DESCRIPTION OF THE EMBODIMENT

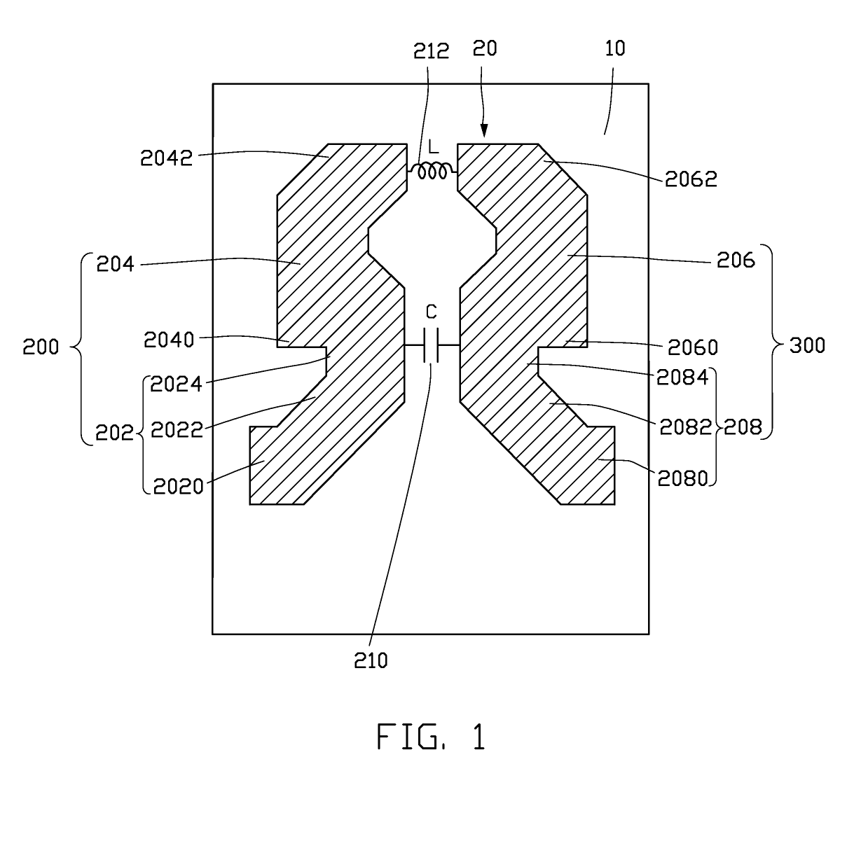

FIG. 1 is a schematic diagram of a low-pass filter 20 in accordance with an embodiment of the invention.

In this embodiment, the low-pass filter 20 is disposed on a substrate 10. The low-pass filter 20 includes an input portion 202, an output portion 208, a first transmission portion 204, a second transmission portion 206, a capacitance component 210, and an inductance component 212. The input portion 202 and the first transmission portion 204 co-form an input part 200. The second transmission portion 206 and the output portion 208 co-form an output part 300.

The first transmission portion 204 and the second transmission portion 206 are in axial symmetry. The first transmission portion 204 is generally C-shaped. The first transmission portion 204 includes a first connection section 2040 electronically connected to the input portion 202 and a first open end 2042. The first transmission portion 204 and the input portion 202 co-form an S-shape. The second transmission portion 206 includes a second connection section 2060 electronically connected to the output portion 208 and a second open end 2062. The second transmission portion 206 and the output portion 208 co-form an inverse S-shape.

The input portion 202 is used for inputting electromagnetic signals. The output portion 208 is used for outputting electromagnetic signals. In this embodiment, the input portion 202 and the output portion 208 are in axial symmetry. The input portion 202 includes an input end 2020, a first oblique section 2022, and a first vertical section 2024 which are electronically connected end to end. The extension direction of the input end 2020 is substantially vertical to that of the first vertical section 2024. The first vertical section 2024 is electronically connected to the first connection section 2040.

The output portion 208 includes an output end 2080, a second oblique section 2082, and a second vertical section 2084 which are electronically connected end to end. The extension direction of the output end 2080 is vertical to that of the second vertical section 2084. The second vertical section 2084 is electronically connected to the second connection section 2060.

The capacitance component 210 is electronically connected to the first connection section 2040 and the second connection section 2060. The inductance component 212 is electronically connected to the first open end 2042 and the second open end 2062. In this embodiment, the capacitance of the capacitance component 210 and the inductance of the inductance component 212 are alterable according to different application demands.

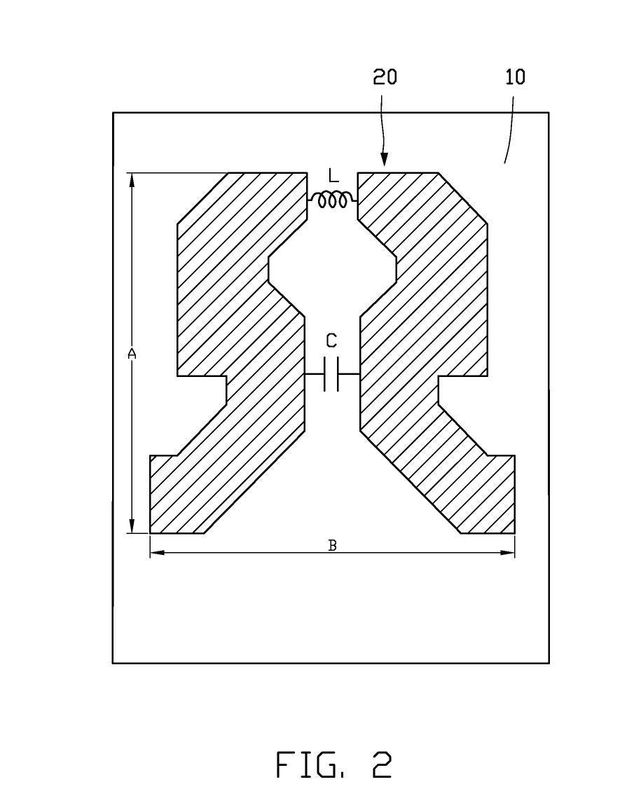

FIG. 2 is a schematic diagram illustrating dimensions of the low-pass filter 20. In this embodiment, a total length A of the low-pass filter 20 is about 7 millimeter (mm), a total width B thereof is about 6.5 mm, and a total area thereof is about 45.5 square mm.

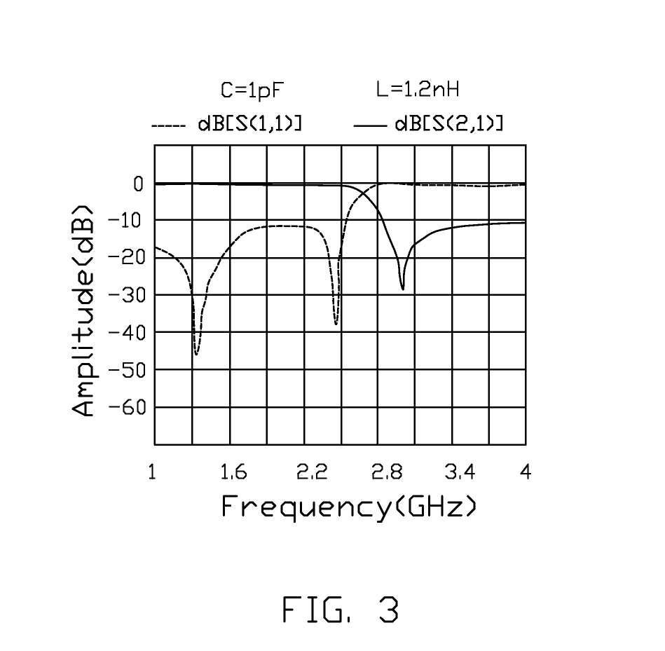

FIG. 3 is a graph of test results showing a return loss of the low-pass filter 20 when the capacitance of the capacitance component 210 is 1 picofarad (pF) and the inductance of the inductance component 212 is 1.2 nanohenry (nH). As shown in FIG. 3, a horizontal axis represents the frequency (in GHz) of the electromagnetic signals traveling through the low-pass filter 20, and a vertical axis represents the amplitude of insertion/return loss (in dB) of the low-pass filter 20. The insertion loss of the electromagnetic signals traveling through the low-pass filter 20 is indicated by a curve labeled dB[S(2, 1)] representing a relationship between an input power and an output power of the electromagnetic signals traveling through the low-pass filter 20, and the insertion loss is represented by the following equation:

Insertion Loss=10*Log [(Output Power)/(Input Power)]

When the electromagnetic signals travels through the low-pass filter 20, a part of the input power is returned to a source of the electromagnetic signals. The part of the input power returned to the source of the electromagnetic signals is called a return power. The return loss of the electromagnetic signals traveling through the low-pass filter 20 is indicated by the dashed curve labeled dB[S(1, 1)], representing a relationship between input power and return power of the electromagnetic signals traveling through the low-pass filter 20, and the return loss is represented by the following equation:

Return Loss=10*Log [(Return Power)/(Input Power)]

For a filter, when an output power of electromagnetic signals in a band pass frequency range is almost equal to an input power thereof, and a return power of the electromagnetic signals is small, it means that a distortion of the electromagnetic signals is small and a performance of the low-pass filter 20 is good. As shown in FIG. 3, the low-pass filter 20 has good performance as a low-pass filter. The absolute amplitude of the return loss in the band pass frequency range is greater than 10. The absolute amplitude of the insertion loss in the band pass frequency range is about 0.

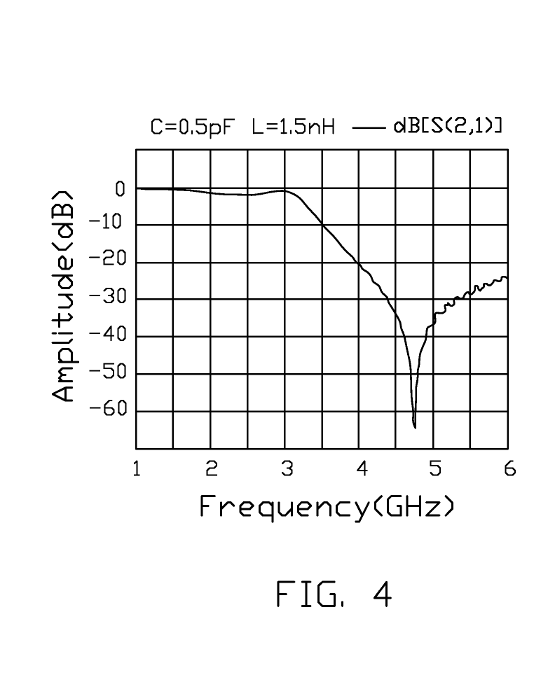

FIG. 4 is a graph of test results showing a return loss of the low-pass filter 20 when the capacitance of the capacitance component 210 is 0.5 pF and the inductance of the inductance component 212 is 1.5 nH.

As shown in FIG. 4, the absolute amplitude of the insertion loss in the band pass frequency range is about 0. The performance of the low-pass filter 20 is good. A transmission zero point of the low-pass filter 20 is at the frequency of 4.7 GHz.

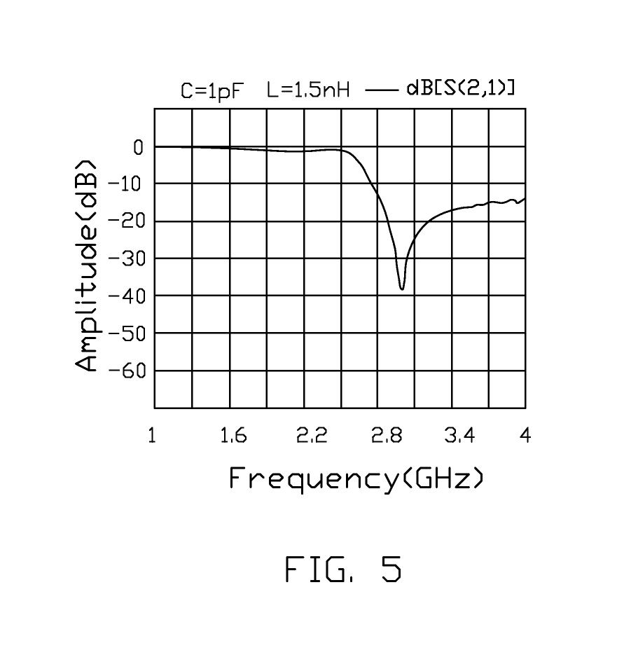

FIG. 5 is a graph of test results showing a return loss of the low-pass filter 20 when the capacitance of the capacitance component 210 is 1 pF and the inductance of the inductance component 212 is 1.5 nH.

As shown in FIG. 5, the absolute amplitude of the insertion loss in the band pass frequency range is about 0. The performance of the low-pass filter 20 is good. The transmission zero point of the low-pass filter 20 is at the frequency of 3 GHz.

Comparing FIG. 4 with FIG. 5, the transmission zero point can be altered by changing the capacitance of the capacitance component 210. The transmission zero point of the low-pass filter 20 moves to lower frequency when the capacitance of the capacitance component 210 is increased.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A low-pass filter disposed on a substrate, comprising:
an input portion, for inputting electromagnetic signals;
an output portion, for outputting electromagnetic signals;
a first transmission portion, comprising a first connection section electronically connected to the input portion and a first open end;
a second transmission portion, comprising a second connection section electronically connected to the output portion and a second open end;
a capacitance component, electronically connected to the first connection section and the second connection section; and
an inductance component, electronically connected to the first open end and the second open end.

2. The low-pass filter as recited in claim 1, wherein the input portion comprises an input end, a first oblique section, and a first vertical section, which are electronically connected end to end.

3. The low-pass filter as recited in claim 2, wherein the first vertical section is electronically connected to the first connection section.

4. The low-pass filter as recited in claim 1, wherein the output portion comprises an output end, a second oblique section, and a second vertical section, which are electronically connected end to end.

5. The low-pass filter as recited in claim 4, wherein the second vertical section is electronically connected to the second connection section.

6. The low-pass filter as recited in claim 1, wherein the first transmission portion and the second transmission portion are in axial symmetry.

7. The low-pass filter as recited in claim 6, wherein the first transmission portion and the second transmission portion are substantially C-shaped.

8. The low-pass filter as recited in claim 1, wherein the capacitance of the capacitance component is alterable.

9. The low-pass filter as recited in claim 1, wherein the inductance of the inductance component is alterable.

10. A low-pass filter disposed on a substrate, comprising:
an input part, comprising an input end, a first open end, and a first connection section electronically connected between the input end and the first open end;
an output part, comprising an output end, a second open end, and a second connection section electronically connected between the output end and the second open end;
an alterable capacitance component, electronically connected to the first connection section and the second connection section; and
an alterable inductance component, electronically connected to the first open end and the second open end.

11. The low-pass filter as recited in claim 10, wherein the input part and the output part are in axial symmetry.

12. The low-pass filter as recited in claim 11, wherein the input part is substantially S-shaped.

13. A filter assembly comprising:
a substrate; and
a filter disposed on said substrate, said filter comprising a first part and a second part neighboring and spaced from said first part, said first part comprising an input portion for inputting electromagnetic signals and a first transmission portion, said first transmission portion comprising a first connection section defined at one end thereof to electrically connect to said input portion and a first open end defined at the other end thereof, said second part comprising an output portion for outputting said electromagnetic signals and a second transmission portion, said second transmission portion comprising a second connection section defined at one end thereof to electrically connect to said output portion and a second open end defined at the other end thereof, a first distance between said first connection section and said second connection section, and a second distance between said first open end and said second open end being both smaller than a third distance between other parts of said first transmission portion and other parts of said second transmission portion.

14. The filter assembly as recited in claim 13, wherein said first part and said second part are formed symmetrically to each other.

15. The filter assembly as recited in claim 13, wherein said first and second distances are both smaller than a fourth distance between said input portion and said output portion.

16. The filter assembly as recited in claim 13, wherein a capacitance component is electrically connected between said first connection section and said second connection section.

17. The filter assembly as recited in claim 13, wherein an inductance component is electrically connected between said first open end and said second open end.
